(19) United States
(12) Patent Application Publication
(10) Pub. No.: US 2006/0145587 A1
(43) Pub. Date: Jul. 6, 2006

(54) Material for shadow mask, process for producing the same, shadow mask from the shadow mask material and picture tube including the shadow mask

(75) Inventors: Toshiyuki Ueda, Yamaguchi (JP); Shinichi Aoki, Yamaguchi (JP)

Correspondence Address: BROWDY AND NEIMARK, P.L.L.C.;624 NINTH STREET, NW, SUITE 300, WASHINGTON, DC, 20001-5303, US

(73) Assignee: Toyo Kohan Co. Ltd., Chiyoda-ku (JP)

(21) Appl. No.: 10/539,608

(22) PCT Filed: Aug. 18, 2003
(86) PCT No.: PCT/JP03/10403

§ 371 Date: Dec. 13, 2005

(51) Int. Cl. H01J 29/81; H01J 29/80

(52) U.S. Cl. 313/402; 313/403

(57) ABSTRACT

A material for shadow mask excelling in tensile strength and magnetic properties; a process for producing the same; a shadow mask from the shadow mask material; and a picture tube including the shadow mask. A billet comprising C: ≦0.004 wt. %, Si: ≦0.03 wt. %, Mn: 0.1 to 0.5 wt. %, P: ≦0.02 wt. %, S: ≦0.02 wt. %, Al: 0.01 to 0.07 wt. %, N: ≦0.0040 wt. %, B: ≦0.01 wt. %, Nb: ≦0.1 wt % and Ti: 0.0001 to 0.1 wt. % with the remainder composed of Fe and unavoidable impurities is subjected to hot rolling, pickling and cold rolling, further to continuous annealing or box annealing so as to regulate the content of residual C to 0.003 wt. % or less, and still further to secondary cold rolling at a rolling rate of 20 to 92%. Thus, a material for shadow mask is obtained.

### TECHNICAL FIELD

This invention relates to a shadow mask material used for shadow masks used in color picture tubes, a process for producing the same, a shadow mask using the shadow mask material and a picture tube including the shadow mask.

### BACKGROUND ART

A cold rolled steel sheet used as a shadow mask material has hitherto been produced by a production process as will now be described. A very low-carbon steel manufactured by an iron and steel manufacturer is subjected to finish hot rolling. Its finish temperature may be higher or lower than its Ar₃ transformation point. Then, after pickling, cold rolling into a specific thickness and degreasing, it is decarburization annealed and subjected to secondary cold rolling at a draft of 50% or above into a final product thickness, as required.

It has been proposed that a shadow mask material be produced from a very low-carbon steel containing not more than 0.0025% by weight of carbon by controlling the atmosphere for its continuous annealing process and thereby promoting its decarburization reaction to improve its etching properties and press formability, and more specifically, it has been proposed that the addition of Nb be effective for stabilizing a solid solution of carbon (JP-A-8-269627).

The cold rolled steel sheet manufactured by this manufacturing process is subjected to photoetching in an etching factory, is annealed for softening and pressed into a specific shape in a press factory and is, then, annealed in an oxidizing atmosphere to have an oxide film called a blackening film formed on its surface to prevent the formation of red rust and lower its radiation ratio, whereby a shadow mask is obtained. The important properties required of a shadow mask material are its soft magnetic properties and its tensile strength, particularly its tensile strength in the direction normal to its rolling direction when its handling after photoetching is taken into account. In addition, it has to be a material which is free from any stretcher strain produced by a solid solution of carbon when the mask is press formed. According to the studies made by the inventors of this invention, those requirements are satisfied by providing a coercive force of 130 A/m or less and a tensile strength of 500 MPa or more in the direction normal to he rolling direction and reducing the solid solution of carbon and nitrogen to prevent stretcher strain from being produced when the mask is press formed, but the conventional method as described above has still been unsatisfactory as failing to provide the above properties steadily at a low cost.

It is, therefore, an object of this invention to provide a shadow mask material which has a tensile strength of 500 MPa or more in the direction normal to the rolling direction in view of its handling after photoetching and a coercive force Hc of 130 A/m or less as its magnetic properties and which will be free from any stretcher strain produced by a solid solution of carbon when a mask is press formed, and a process for producing it, and to form a shadow mask from such a shadow mask material and obtain a picture tube having such a shadow mask incorporated therein.

### DISCLOSURE OF THE INVENTION

A shadow mask material of this invention which overcomes the above problems is characterized by containing 0.0001 to 0.1% by weight of Ti and not more than 0.003% by weight of C in its composition, the balance thereof being Fe and unavoidable impurities.

Another shadow mask material of this invention which overcomes the above problems is characterized by containing not more than 0.003% by weight of C, not more than 0.03% by weight of Si, 0.1 to 0.5% by weight of Mn, not more than 0.02% by weight of P, not more than 0.02% by weight of S, 0.01 to 0.07% by weight of Al, not more than 0.0040% by weight of N, not more than 0.01% byweight ofB, not more than 0.1% by weight of Nb and 0.0001 to 0.1% by weight of Ti in its composition, the balance thereof being Fe and unavoidable impurities.

A process of this invention for producing a shadow mask material which overcomes the above problems is characterized by hot rolling a steel slab containing not more than 0.004% by weight of C and 0.0001 to 0.1% by weight of Ti in its composition, the balance thereof being Fe and unavoidable impurities, pickling a hot rolled product, cold rolling a pickled product, subjecting a cold rolled product to continuous or box annealing to reduce its carbon content to not more than 0.003% by weight and subjecting it to secondary cold rolling at a draft of 20 to 92%.

Another process of this invention for producing a shadow mask material that overcomes the above problems is characterized by hot rolling a steel slab containing not more than 0.004% by weight of C, not more than 0.03% by weight of Si, 0.1 to 0.5% by weight of Mn, not more than 0.02% by weight of P, not more than 0.02% by weight of S, 0.01 to 0.07% by weight of Al, not more than 0.0040% by weight of N, not more than 0.01% by weight of B, less than 0.01% by weight of Nb and 0.0001 to 0.1% by weight of Ti in its composition, the balance thereof being Fe and unavoidable impurities, pickling a hot rolled product, cold rolling a pickled product, subjecting a cold rolled product to continuous or box annealing to reduce its carbon content to not more than 0.003% by weight and subjecting it to secondary cold rolling at a draft of 20 to 92%.

Still another process of this invention for producing a shadow mask material that overcomes the above problems is characterized by hot rolling a steel slab containing not more than 0.004% by weight of C, not more than 0.03% by weight of Si, 0.1 to 0.5% by weight of Mn, not more than 0.02% by weight of P, not more than 0.02% by weight of S, 0.01 to 0.07% by weight of Al, not more than 0.0040% by weight of N, not more than 0.01% by weight of B, 0.01 to 0.1% by weight of Nb and 0.0001 to 0.1% by weight of Ti in its composition, the balance thereof being Fe and unavoidable impurities, pickling a hot rolled product, cold rolling a pickled product, subjecting a cold rolled product to continuous or box annealing to reduce its carbon content to not more than 0.003% by weight and subjecting it to secondary cold rolling at a draft of 70% or less.

A shadow mask of this invention is characterized by using a shadow mask material having the composition as set forth above, or by being produced from a shadow mask material as produced by any of the processes as set forth above. A picture tube of this invention is characterized by being a picture tube having incorporated therein a shadow mask as produced by the process for producing a shadow mask as set forth above.

### BEST MODE OF CARRYING OUT THE INVENTION

The invention will now be described in detail based on modes of carrying it out.

A shadow mask material according to one mode of carrying out this invention is preferably a hot rolled steel sheet containing not more than 0.003% by weight of C (not more than 0.004% by weight of C before annealing), not more than 0.03% by weight of Si, 0.1 to 0.5% by weight of Mn, not more than 0.02% by weight of P, not more than 0.02% by weight of S, 0.01 to 0.07% by weight of Al, not more than 0.0040% by weight of N, not more than 0.01% by weight of B, not more than 0.1% by weight of Nb and 0.0001 to 0.1% by weight of Ti in its composition, the balance thereof being Fe and unavoidable impurities, for which the reasons will now be stated.

Ti Content:

The steel preferably has a titanium content of 0.0001 to 0.1% by weight. It is more preferably from 0.0005 to 0.07% by weight and still more preferably from 0.041 to 0.07% by weight. The steel preferably has a low Ti content, since Ti forms a carbonitride with C and N and thereby reduces a solid solution of C and N and thereby stretcher strain and it has to be at least 0.0001% by weight. It has, however, an upper limit of 0.1% by weight, since too high a Ti content leads to an elevated recrystallization temperature at the time of softening annealing prior to the formation of a mask. It is in the range of 0.041 to 0.07% by weight that Ti produces the best result in the composition according to this invention.

C Content:

The carbon content of the hot rolled steel sheet exerts a serious effect on its annealing for decarburization and preferably has an upper limit of 0.0040% by weight, since if it exceeds 0.004% by weight, no satisfactory decarburization is made by continuous or box annealing, but an elevated annealing temperature and a prolonged annealing time are required for realizing a specific residual carbon content of 0.003% byweightor less, preferably 0.0022% by weight or less, in a shadow mask material and lead to an increased cost of production and a lowering in productivity. The steel sheet as decarburized has a residual carbon content of 0.003% by weight, preferably 0.0022% by weight, or less.

Si Content:

The shadow mask material preferably has as low a silicon content as possible with an upper limit of 0.03% by weight, since Si is an element which hinders blackening in the blackening stage of picture tube manufacture, while it is an element which Al-killed steel unavoidably contains. It is more preferably 0.025% by weight, still more preferably 0.02% by weight, or less.

Mn Content:

Manganese in a hot rolled steel sheet is a component necessary for preventing its red-heat embrittlement by the sulfur which it contains as impurity, and as the very thin shadow mask material of this invention is likely to crack easily during cold rolling, it is preferable to add a specific amount of Mn thereto. It is preferable to add 0.1% by weight, more preferably 0.25% by weight, or more in order for its addition to be effective.

However, if its amount exceeds 0.5% by weight, it lowers the formablity of steel and therefore, its upper limit is preferably 0.5%, more preferably 0.40% and still more preferably 0.35%, by weight or less.

P Content:

The shadow mask material preferably has a low phosphorus content, since it divides the crystal grains of steel so finely and thereby affects its magnetic properties adversely. This is particularly the case with a very thin shadow mask material according to this invention and 0.02% by weight or less is preferred.

S Content:

The sulfur in a hot rolled steel sheet is an element which it unavoidably contains, but as it is an impurity causing its red-heat embrittlement, it preferably has as low a sulfur content as possible. It is desirable to eliminate sulfur in a positive way from a very thin shadow mask material according to this invention, as it is likely to crack easily when it is cold rolled. In this connection, it preferably has a sulfur content of 0.02% by weight or less, and more preferably 0.01% by weight or less.

Al Content:

In a steel making process, aluminum is added to a molten bath as a deoxidizing agent and removed as a slag, and if its amount is too small, no steady deoxidizing result can be obtained. Therefore, it is preferable to add 0.01% by weight or more and more preferably 0.02% by weight or more. No addition over 0.07% by weight can, however, be expected to any substantially improved result. According to this invention, the coarsening of crystal grains is intended and the fine division thereof by the excessive addition of aluminum is undesirable and 0.07% by weight or less is preferable and 0.04% by weight or less is more preferable.

B Content:

The addition of boron is desirable, since in a hot rolled steel sheet, boron forms a nitride with nitrogen and thereby restrains any stretcher strain, but a steel sheet according to this invention does not necessarily need boron, since it contains titanium.

If any boron is added, therefore, its amount is limited to 0.01% by weight or less so that no excessively elevated recrystallization temperature may be required for annealing prior to press forming.

Nb Content:

The addition of niobium is desirable, since in a hot rolled steel sheet, niobium forms a carbonitride with carbon and nitrogen and thereby restrains any stretcher strain, but a steel sheet according to this invention does not necessarily need niobium, since it contains titanium, as in the case of boron. Niobium is more influential than titanium in making an elevated recrystallization temperature necessary for softening annealing before a mask is formed, and in producing finely divided crystal grains upon blackening annealing after the mask is formed, and thereby affecting its magnetic properties adversely.

Therefore, niobium is limited to 0.1% by weight or less so that no excessively elevated recrystallization temperature may be required for annealing prior to press forming.

The draft which is allowable for secondary cold rolling is based on the Nb content of the material and when its Nb content is 0.01 to 0.1% by weight, the allowable draft is 70% or less and when it is less than 0.01% by weight, the allowable draft is 20 to 92%.

Balance:

There is no limitation as to the balance of the composition which is composed of Fe and other elements that may unavoidably be present in the steel without affecting its etching property or press formability.

Description will now be made of a process for producing a very thin shadow mask material according to another mode of carrying out this invention.

The process for producing a very thin shadow mask material according to this invention includes heating a steel slab having the composition as set forth above to between 1100° C. and 1250° C. and hot rolling it, pickling it and subjecting it to primary cold rolling. Then, it includes continuous annealing a cold rolled sheet at a sheet temperature of 750° C. or above, preferably 800° C. or above, for a soaking time of 60 seconds or more, or box annealing it at a sheet temperature of 590° C. for a soaking time of six hours or more to realize a residual carbon content of 0.003% by weight or less and conducting its secondary cold rolling at a draft of 20 to 92%. Then, it may include temper rolling and annealing prior to press forming, as required.

The process as described will now be described in further detail step by step.

(Step of Hot Rolling)

A slab is preferably heated to a hot rolling temperature of 1100° C. or above, as its hot rollability is lowered at a temperature below 1100° C. Too high a slab heating temperature, however, dissolves AlN in the slab completely and produces a hot rolled sheet having finely divided crystal grains and therefore having inferior magnetic properties. In other words, it has a high Hc value. Accordingly, a slab heating temperature not exceeding 1250° C. is preferred.

A finish hot rolling temperature is an important factor for the control of crystal grains and if it is higher than the Ar₃ transformation point, γ→α transformation occurs after finish rolling, producing finely divided crystal grains and thereby affecting the magnetic properties of the material adversely with a high Hc value, but as it does not exceed 130 A/m, the finish rolling temperature is not particularly limited.

It is, however, sometimes the case that the specifications of a customer may prefer a lower Hc value, and in such a case, it is necessary to see that γ→α transformation end before finish rolling, so that no γ→α transformation may occur between finish rolling and take-up. Accordingly, the finish hot rolling temperature is so selected as to be from 0° C. to 30° C. and preferably from 10° C. to 20° C. lower than the Ar₃ transformation point, and for the material according to this invention, therefore, it is from 850° C. to 880° C. and preferably from 860° C. to 870° C.

The Ar₃ transformation point of a given material, however, depends on its composition, though that of the material according to this invention is about 880° C. An important thing is to terminate the finish hot rolling of any material at a temperature which is from 0° C. to 30° C. and preferably from 10° C. to 20° C. lower than its Ar₃ transformation point.

A take-up temperature of 540° C. to 700° C. is preferable in view of the stability in quality of a hot rolled sheet along its width and length, and a take-up temperature of 650° C. to 700° C. is more preferable to produce a hot rolled sheet having coarse crystal grains. The take-up temperature has an upper limit of 700° C. which is not set for the magnetic properties of the material, but is set for the removal of scale by pickling.

(Steps of Pickling and Primary Cold Rolling)

Pickling and primary cold rolling may be performed under ordinarily employed conditions. It is desirable for a primary cold rolled sheet to have a thickness of 0.6 mm or less to ensure the efficient decarburization annealing of a very thin shadow mask material according to this invention.

(Step of Annealing)

The step of continuous annealing is an important step for this invention and is preferably performed by holding the sheet at a temperature of 750° C. or above, more preferably 800° C. or above, for a soak time of 30 seconds or more in an annealing atmosphere having a hydrogen gas concentration of 0 to 75%, more preferably 10% or less, the rest thereof being nitrogen gas, and having a dew point of from −30° C. to +40° C., more preferably from −20° C. to +30° C. The continuous annealing temperature dictates the efficiency of decarburization of steel and its magnetic properties and if it is lower than 750° C., not only a long time of decarburization is necessary and results in lower productivity, but also the lack of uniformity in the structure of recrystallization obtained by annealing disables the material to obtain uniform magnetic properties. Therefore, the annealing temperature is preferably 750° C. or above. It is more preferably 800° C. or above.

The continuous annealing is preferably performed with a soak time of 60 seconds or more. If it is less than 60 seconds, decarburization is insufficient for a very thin shadow mask material and is difficult to carry out until an intended carbon content of 0.003% or less is realized therefor. Although no upper limit in particular may have to be set for the soak time, a period not exceeding 180 seconds is desirable for productivity and for preventing any excessive coarsening of crystal grains.

Box annealing is preferably performed with a soak time of six hours or more at a sheet temperature of 590° C. or above. It is performed in the same annealing atmosphere as in the case of continuous annealing. The lower limit of 590° C. for the box annealing temperature is set for the same reason as in the case of continuous annealing. The lower limit of six hours for the box annealing time is set for the same reason as in the case of continuous annealing.

(Hydrogen Concentration and Dew Point of Annealing Atmosphere)

As this invention prefers a lower carbon content, while not imposing any limitation as to the annealing atmosphere, decarburization annealing is preferably performed in an atmosphere having a hydrogen gas concentration of 10% or less and a dew point of from −30° C. to +40° C., more preferably from −20° C. to +30° C.

(Step of Secondary Cold Rolling After Annealing)

It is important to perform secondary cold rolling after annealing at a draft of 92% or less and preferably 90% or less to obtain an Hc value of 130 A/m or less. The material obtained by secondary rolling is a mask material and is required to have a tensile strength of 500 MPa or more in the direction normal to its rolling direction in order to withstand handling to an improved extend until its etching. Therefore, the secondary rolling is preferably performed at a draft of 20% or more and more preferably 38% or more.

(Step of Temper Rolling)

The steel sheet as obtained by secondary cold rolling may have an adequate surface roughness imparted by temper rolling. Its temper rolling may be performed by using rolls having an adequate roughness to give the sheet an average surface roughness Ra (JIS B0601) of 0.1 to 1 Am. An Ra value below 0.1 μm is undesirable, since resist does not closely adhere to the sheet, and an Ra value over 1 μm is also undesirable, since resist is likely to remain on the sheet even after development and thereby cause uneven etching with a ferric chloride solution.

(Step of Annealing Prior to Press Forming)

After its secondary or temper rolling as described, the shadow mask material may be shipped to a further processing factory, or may alternatively be annealed again. Continuous annealing may be continued for 20 seconds or longer at 600° C. to 800° C., and box annealing may be continued for five or preferably eight hours or longer at 500° C. to 750° C.

### EXAMPLES

The invention will now be described in further detail based on examples.

Steel slabs having the chemical compositions shown in Table 1 were hot rolled into hot rolled steel sheets having a thickness of 2.3 mm and after pickling, they were cold rolled into cold rolled sheets having a thickness of 0.6 mm. Then, they were annealed for decarburization under different conditions. In Table 1, the word “trace” means a very small amount that could not be measured. Table 2 shows the amounts of carbon as determined in the sheets as annealed. They were, then, subjected to secondary cold rolling to produce very thin shadow mask materials having a thickness of 0.04 to 0.25 mm. In Example 5, temper rolling followed secondary cold rolling to give an average surface roughness Ra (JIS B0601) of 0.4 μm.

The materials produced as described were evaluated for their properties. The results of their evaluations are shown in Table 2.

[Evaluation for Tensile Strength (TS)]

The tensile strength (TS for tensile strength) of each JIS #5 test specimen was examined in the direction normal to its rolling direction by using a Tensilon meter.

[Evaluation for Magnetic Properties (Hc)]

Each material was annealed at 720° C. for 10 minutes in an atmosphere containing 5.5% by volume of hydrogen gas, the rest thereof being nitrogen gas, and having a dew point of 10° C., and was loaded with a magnetic field of 796 m/A for the determination of its coercive force (Hc) by the four-pole Epstein method (a method in which primary and secondary windings were put on the material and an external magnetic field was applied thereto).

Tables 1 and 2 show the materials according to the examples of this invention and according to comparative examples, the processes for their production, their tensile strength and their coercive force (Hc) as determined by the four-pole Epstein method.

TABLE 1
Chemical composition of samples

| Example or | | | | | | | | | | |
|---|---|---|---|---|---|---|---|---|---|---|
| Comparative | Chemical Composition (wt %) | | | | | | | | | |
| Example | C | Si | Mn | P | S | Al | N | B | Ti | Nb |
| Example 1 | 0.0021 | 0.02 | 0.15 | 0.010 | 0.012 | 0.042 | 0.0021 | trace | 0.045 | trace |
| Example 2 | 0.0027 | 0.03 | 0.35 | 0.025 | 0.019 | 0.062 | 0.0055 | 0.0020 | 0.065 | 0.011 |
| Example 3 | 0.0025 | 0.01 | 0.21 | 0.018 | 0.008 | 0.079 | 0.0092 | 0.0066 | 0.072 | 0.018 |
| Example 4 | 0.0021 | 0.02 | 0.15 | 0.010 | 0.012 | 0.042 | 0.0021 | trace | 0.045 | trace |
| Example 5 | 0.0038 | 0.04 | 0.42 | 0.030 | 0.018 | 0.055 | 0.0094 | 0.0050 | 0.001 | 0.050 |
| Com. Ex. 1 | 0.0019 | 0.04 | 0.22 | 0.011 | 0.012 | 0.033 | 0.0052 | trace | 0.1120 | trace |
| Com. Ex. 2 | 0.0014 | 0.01 | 0.31 | 0.016 | 0.013 | 0.032 | 0.0028 | 0.0020 | trace | trace |
| Com. Ex. 3 | 0.0030 | 0.04 | 0.42 | 0.030 | 0.018 | 0.055 | 0.0094 | 0.0050 | 0.001 | 0.050 |
| Com. Ex. 4 | 0.0021 | 0.02 | 0.15 | 0.010 | 0.012 | 0.042 | 0.0021 | trace | 0.045 | trace |
| Com. Ex. 5 | 0.0021 | 0.02 | 0.15 | 0.010 | 0.012 | 0.042 | 0.0021 | trace | 0.045 | trace |
| Com. Ex. 6 | 0.0021 | 0.02 | 0.15 | 0.010 | 0.012 | 0.042 | 0.0021 | trace | 0.045 | trace |

TABLE 2
Conditions for preparation of samples and their properties

| Example or | Annealing | | | Secondary | C content after | Tensile | Magnetic | | | |
|---|---|---|---|---|---|---|---|---|---|---|
| Comparative | | | Dew | cold rolling | decarburization | strength | properties | Evaluation | | Overall |
| Example | Method | Temperature | point | draft | (wt %) | TS (MPa) | Hc (A/m) | TS | Hc | evaluation |
| Example 1 | Continuous | 820° C. | −25° C. | 70% | 0.0015 | 650 | 95 | ⊚ | ⊚ | ⊚ |
| Example 2 | Continuous | 820° C. | +5° C. | 35% | 0.0011 | 505 | 80 | ◯ | ⊚ | ◯ |
| Example 3 | Continuous | 820° C. | +5° C. | 91% | 0.0007 | 700 | 125 | ⊚ | ◯ | ◯ |
| Example 4 | Box | 600° C. | +5° C. | 70% | 0.0018 | 670 | 125 | ⊚ | ◯ | ◯ |
| Example 5 | Continuous | 820° C. | +5° C. | 65% | 0.0029 | 710 | 125 | ⊚ | ◯ | ◯ |
| Com. Ex. 1 | Continuous | 820° C. | −25° C. | 70% | 0.0018 | 770 | 185 | ⊚ | X | X |
| Com. Ex. 2 | Continuous | 820° C. | −25° C. | 30% | 0.0011 | 490 | 66 | X | ⊚ | X |
| Com. Ex. 3 | Continuous | 820° C. | −25° C. | 75% | 0.0028 | 740 | 138 | ⊚ | X | X |
| Com. Ex. 4 | Continuous | 730° C. | −25° C. | 70% | 0.0021 | 780 | 190 | ⊚ | X | X |
| Com. Ex. 5 | Continuous | 820° C. | −25° C. | 93% | 0.0017 | 720 | 131 | ⊚ | X | X |
| Com. Ex. 6 | Continuous | 820° C. | −25° C. | 18% | 0.0014 | 430 | 61 | X | ⊚ | X |

As is obvious from Tables 1 and 2, Examples 1 to 5 gave shadow mask materials having good magnetic properties as indicated by an Hc value below 130 A/m when a temperature of 720° C. had been employed for annealing prior to press forming by a press factory. They also showed a tensile strength which was higher than 500 MPa.

The material according to Comparative Example 1 did not wrinkle during processing owing to too much titanium, but had an undesirably high value of magnetic property. The material according to Comparative Example 2 had an undesirably low tensile strength and wrinkled during processing because of too little titanium. The material according to Comparative Example 3 had a high value of magnetic property (Hc) because of its secondary cold rolling at too high a draft for its niobium content. The material according to Comparative Example 4 had a mechanical strength lower than 500 MPa because of its low continuous annealing temperature and would not withstand handling by the customer. The material according to Comparative Example 5 had a high value of magnetic property, Hc, because of too high a draft of secondary rolling. On the other hand, the material according to Comparative Example 6 had a low tensile strength because of too low a draft of secondary rolling.

### INDUSTRIAL APPLICABILITY

As is obvious from the foregoing, the shadow mask material of this invention makes it possible to reduce any stretcher strain by a carbonitride formed by titanium and thereby reducing a solid solution of carbon and nitrogen owing to its composition and production process as described above, especially the addition of 0.0001 to 0.1% by weight of titanium to low carbon steel and the production processes according to claims 4 and 5. Thus, there is obtained a shadow mask material which is excellent in tensile strength and magnetic properties.

1. A shadow mask material characterized by containing 0.0001 to 0.1% by weight of Ti and not more than 0.003% by weight of C in its composition, the balance thereof being Fe and unavoidable impurities.

2. A shadow mask material characterized by containing not more than 0.003% by weight of C, not more than 0.03% by weight of Si, 0.1 to 0.5% by weight of Mn, not more than 0.02% by weight of P, not more than 0.02% by weight of S, 0.01 to 0.07% by weight of Al, not more than 0.0040% by weight of N, not more than 0.01% by weight of B, not more than 0.1% by weight of Nb and 0.0001 to 0.1% by weight of Ti in its composition, the balance thereof being Fe and unavoidable impurities.

3. A process for producing a shadow mask material characterized by hot rolling a steel slab containing not more than 0.004% by weight of C and 0.0001 to 0.1% by weight of Ti in its composition, the balance thereof being Fe and unavoidable impurities, pickling a hot rolled product, cold rolling a pickled product, subjecting a cold rolled product to continuous or box annealing to reduce its carbon content to not more than 0.003% by weight and subjecting it to secondary cold rolling at a draft of 20 to 92%.

4. A process for producing a shadow mask material characterized by hot rolling a steel slab containing not more than 0.004% by weight of C, not more than 0.03% by weight of Si, 0.1 to 0.5% by weight of Mn, not more than 0.02% by weight of P, not more than 0.02% by weight of S, 0.01 to 0.07% by weight of Al, not more than 0.0040% by weight of N, not more than 0.01% by weight of B, less than 0.01% by weight of Nb and 0.0001 to 0.1% by weight of Ti in its composition, the balance thereof being Fe and unavoidable impurities, pickling a hot rolled product, cold rolling a pickled product, subjecting a cold rolled product to continuous or box annealing to reduce its carbon content to not more than 0.003% by weight and subjecting it to secondary cold rolling at a draft of 20 to 92%.

5. A process for producing a shadow mask material characterized by hot rolling a steel slab containing not more than 0.004% by weight of C, not more than 0.03% by weight of Si, 0.1 to 0.5% by weight of Mn, not more than 0.02% by weight of P, not more than 0.02% by weight of S, 0.01 to 0.07% by weight of Al, not more than 0.0040% by weight of N, not more than 0.01% by weight of B, 0.01 to 0.1% by weight of Nb and 0.0001 to 0.1% by weight of Ti in its composition, the balance thereof being Fe and unavoidable impurities, pickling a hot rolled product, cold rolling a pickled product, subjecting a cold rolled product to continuous or box annealing to reduce its carbon content to not more than 0.003% by weight and subjecting it to secondary cold rolling at a draft of 70% or less.

6. A shadow mask formed from a shadow mask material as set forth in claim 1.

7. A shadow mask manufactured by employing a process for producing a shadow mask material as set forth in claim 3.

8. A picture tube having incorporated therein a shadow mask as set forth in claim 6.

9. A shadow mask formed from a shadow mask material as set forth in claim 2.

10. A shadow mask manufactured by employing a process for producing a shadow mask material as set forth in claim 4.

11. A shadow mask manufactured by employing a process for producing a shadow mask material as set forth in claim 5.

12. A picture tube having incorporated therein a shadow mask as set forth in claim 7.

13. A picture tube having incorporated therein a shadow mask as set forth in claim 9.

14. A picture tube having incorporated therein a shadow mask as set forth in claim 10.

15. A picture tube having incorporated therein a shadow mask as set forth in claim 11.
